(19) United States
(12) Patent Application Publication
(10) Pub. No.: US 2014/0143657 A1
(43) Pub. Date: May 22, 2014

(54) GENERATION OF TOPICAL SUBJECTS FROM ALERT SEARCH TERMS

(71) Applicant: Google Inc., Mountain View, CA (US)

(72) Inventors: Adam D. Smith, Mountain View, CA (US); Brian A. Singerman, San Francisco, CA (US); Naga Sridhar Kataru, Mountain View, CA (US)

(73) Assignee: Google Inc., Mountain View, CA (US)

(21) Appl. No.: 14/163,306

(22) Filed: Jan. 24, 2014

Related U.S. Application Data
(63) Continuation of application No. 11/236,869, filed on Sep. 28, 2005, now abandoned.

(51) Int. Cl. G06F 17/30; G06F 17/22

(52) U.S. Cl. CPC G06F 17/3053; G06F 17/2247; G06F 17/30864
USPC 715/234; 707/723; 707/706

(57) ABSTRACT

Topical subjects are identified from search terms that are submitted by users registering for alerts. In one implementation, registration requests to transmit email alerts to a user are received and stored. Topical subjects are identified based on an analysis of the email alerts that were registered in a predetermined time frame.

### FIELD OF THE INVENTION

Implementations described herein generally relate to detecting subjects that are currently of interest to a user community.

### DESCRIPTION OF THE RELATED ART

In an increasingly networked world, consumers frequently use online sources to access information. For example, search engines are a popular tool through which users enter a search query describing information of interest and receive back documents or links to documents that relate to the search query. Search engines may be tailored to a particular area of interest, such as a general web search engine, a news search engine, or a shopping search engine.

Users may find or follow information of interest using tools other than search engines. For example, users may frequent particular web pages that relate to a subject of interest or subscribe to an alert service, such as an email alert service. In an email alert service, a user may subscribe to one or more topics of interest by describing the topic of interest via search terms that the user provides to an alert provider. When news items or other documents of interest are determined to match a registered alert, the alert provider may transmit the document (or a link to the document) to the user via, for example, email. This type of alert service allows users to easily track topics or subjects in which they are interested.

### SUMMARY

One aspect is directed to a computer-implemented method that includes receiving a registration request to transmit alerts to a user, storing the received registration request, and identifying topical subjects based on an analysis of alerts that were registered in a predetermined time frame from multiple users.

Another aspect is directed to a method of identifying subjects topical to a group of users. The method includes aggregating alerts registered by the users, each of the alerts including search terms entered by the users that define topics for which the users are interested in receiving information. The method further includes analyzing the aggregated alerts to locate topics that have been registered most frequently.

Yet another aspect is directed to an alert engine. The alert engine includes logic configured to allow users of the alert engine to register for alerts about subjects in which the users are interested; logic configured to analyze alerts registered within a predetermined time frame to identify popular alert registrations; and logic configured to output topical subjects that correspond to the identified popular alerts.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary system in which concepts consistent with the principles of the invention may be implemented;

FIG. 2 is an exemplary diagram of one of the computing devices shown in FIG. 1;

FIG. 3 is a flow chart conceptually illustrating exemplary operations of the alert engine shown in FIG. 1;

FIG. 4 is a diagram illustrating an exemplary graphical interface through which a user may register alerts;

FIG. 5 is a diagram of an exemplary email alert displayed in a graphical interface;

FIG. 6 is a flowchart illustrating exemplary operations performed by the topical subject generator shown in FIG. 1;

FIGS. 7A and 7B are diagrams illustrating exemplary tables that store aggregated alert search terms;

FIG. 8 is a diagram illustrating an exemplary implementation of a search engine that uses topical alerts generated by the topical subject generator shown in FIG. 1; and

FIG. 9 is a diagram illustrating an exemplary implementation of an interface for creating new alerts.

### DETAILED DESCRIPTION

The following detailed description of the invention refers to the accompanying drawings. The detailed description does not limit the invention.

### Overview

Implementations consistent with the principles of the invention use information relating to current user interests, such as registered alert search terms, to generate an indication of subjects that a user community considers to be topical. The identified topical subjects can be used to enhance the users' online experiences.

As a conceptual example of an implementation consistent with aspects of the invention, consider an email alert provider that allows users to enter alert search terms that define topics in which the user is currently interested. For example, a user interested in news about the actor Colin Farrell may register to be notified about new news documents that contain the search terms “Colin Farrell.” The alert provider can use an aggregation of such alert search terms to learn about topics or subjects in which the user community is currently interested. For example, if an unusually large number of users register the search terms “Colin Farrell,” the alert provider may infer that this actor is currently of particular interest to users. The alert provider may use this information to enhance the online experience of its users, such as by, for example, suggesting that a user may be interested in receiving alerts about “Colin Farrell” or by more prominently featuring news articles about Colin Farrell on its web site.

### System Description

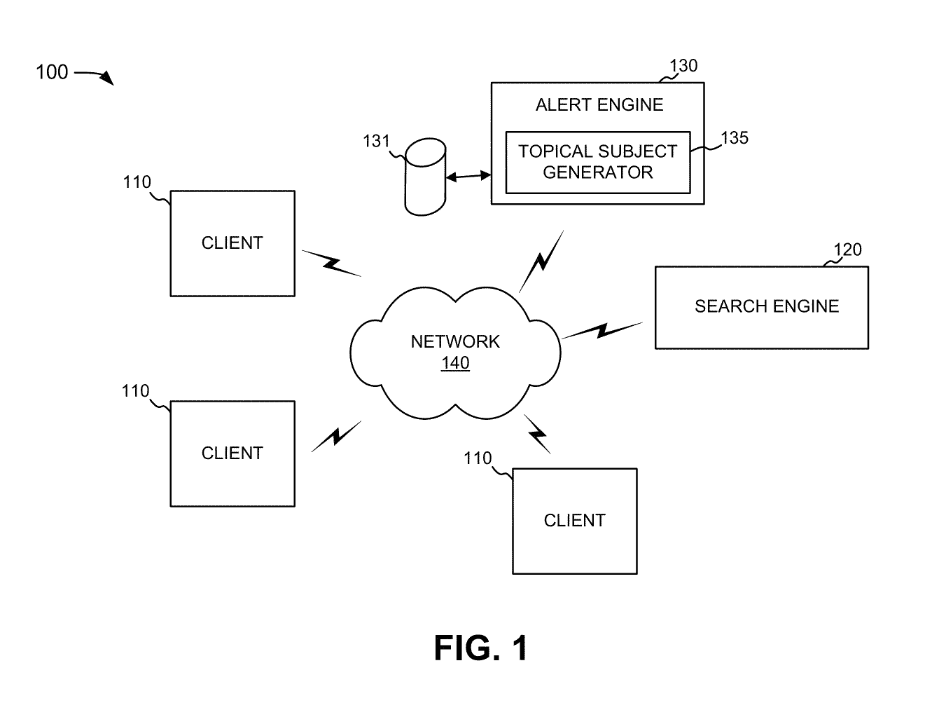

FIG. 1 is a diagram of an exemplary system 100 in which concepts consistent with the principles of the invention may be implemented. System 100 may include multiple clients 110 that can connect to servers, labeled as search engine 120 and alert engine 130, via a network 140. Network 140 may include a local area network (LAN), a wide area network (WAN), a telephone network, such as the Public Switched Telephone Network (PSTN), an intranet, the Internet, or a combination of networks. Three clients 110 and two servers (search engine 120 and alert engine 130) are illustrated as connected to network 140 for simplicity. In practice, there may be more clients and/or servers. Also, in some instances, a client may perform one or more functions of a server and a server may perform one or more functions of a client.

A client 110 may include a device, such as a wireless telephone, a personal computer, a personal digital assistant (PDA), a lap top, or another type of computation or communication device, a thread or process running on one of these devices, and/or an object executable by one of these devices. Users of clients 110 may access or receive information from search engine 120 and alert engine 130.

In the implementation shown, search engine 120 may generally index documents and provide documents to clients 110 in response to user search queries. Search engine 120 may be, for example, a general web search engine, or a more specialized search engine, such as a news or shopping search engine.

Alert engine 130 may provide alerts, such as alerts delivered via email, to users that register to receive the alerts. The registered alerts may be stored in database 131. The alerts provided by alert engine 130 may include, for example, documents or links to documents that relate to search terms selected by the user when registering for the alert. Alert engine 130 may additionally include or be associated with topical subject generator 135. Topical subject generator 135 may generally operate to output subjects that are topical to the users of alert engine 130. Although topical subject generator 135 is shown implemented within or as a part of alert engine 130, topical subject generator 135 may be implemented separately from alert engine 130. Topical subject generator 135 will be described in more detail below.

### Exemplary Computing Device Architecture

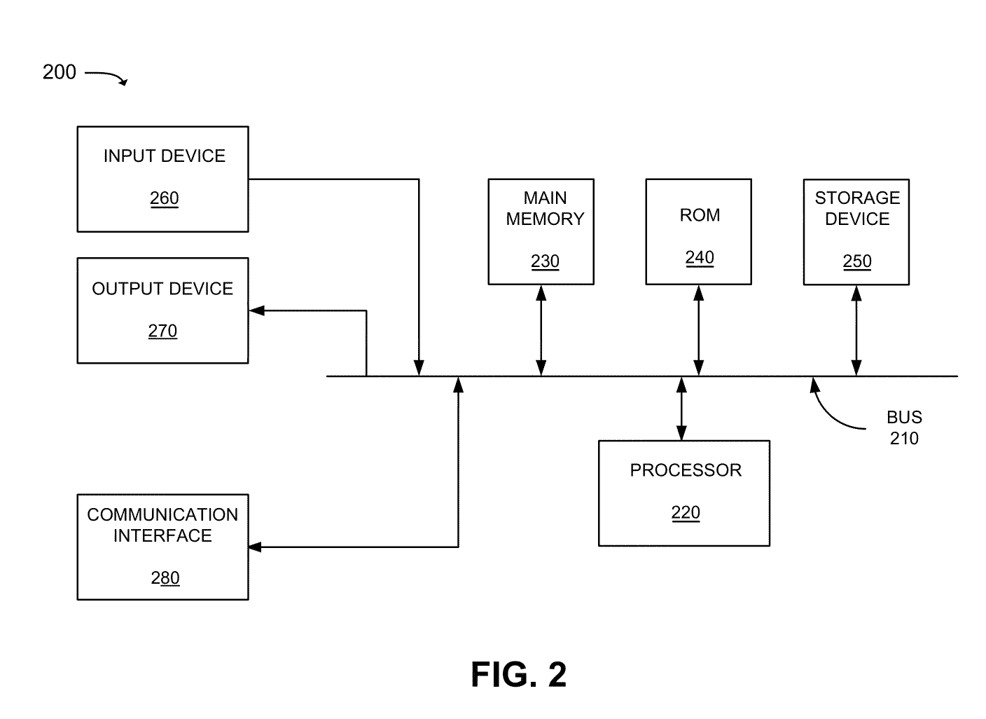

FIG. 2 is an exemplary diagram of computing device 200, such as one of clients 110, search engine 120, or alert engine 130. Computing device 200 may include a bus 210, a processor 220, a main memory 230, a read only memory (ROM) 240, a storage device 250, an input device 260, an output device 270, and a communication interface 280. Bus 210 may include a path that permits communication among the components of computing device 200.

Processor 220 may include any type of processor, microprocessor, or processing logic that may interpret and execute instructions. Main memory 230 may include a random access memory (RAM) or another type of dynamic storage device that may store information and instructions for execution by processor 220. ROM 240 may include a ROM device or another type of static storage device that may store static information and instructions for use by processor 220. Storage device 250 may include a magnetic and/or optical recording medium and its corresponding drive.

Input device 260 may include a mechanism that permits a user to input information to computing device 200, such as a keyboard, a mouse, a pen, voice recognition and/or biometric mechanisms, etc. Output device 270 may include a conventional mechanism that outputs information to the user, including a display, a printer, a speaker, etc. Communication interface 280 may include any transceiver-like mechanism that enables computing device 200 to communicate with other devices and/or systems. For example, communication interface 280 may include mechanisms for communicating with another device or system via a network, such as network 140.

Topical subject generator 135 may be implemented in software and stored in a computer-readable medium, such as memory 230. A computer-readable medium may be defined as one or more physical or logical memory devices and/or carrier waves.

The software instructions defining topical subject generator 135 may be read into memory 230 from another computer-readable medium, such as data storage device 250, or from another device via communication interface 280. The software instructions contained in memory 230 cause processor 220 to perform processes that will be described later. Alternatively, hardwired circuitry may be used in place of or in combination with software instructions to implement processes consistent with the present invention. Thus, implementations consistent with the principles of the invention are not limited to any specific combination of hardware circuitry and software.

### Alert Engine

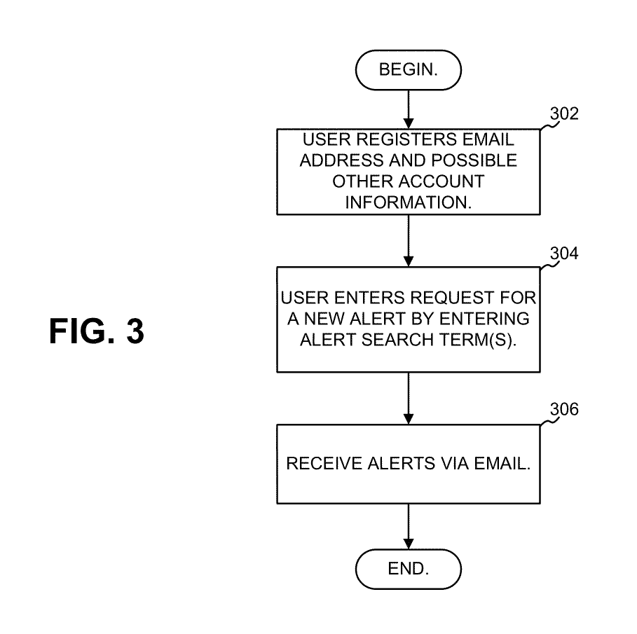

Before describing topical subject generator 135, an implementation of alert engine 130 will first be described. FIG. 3 is a flow chart conceptually illustrating exemplary operations of alert engine 130.

A user may begin to use alert engine 130 by registering with the alert engine (act 302). During the registration process, the user may provide an email address to which email alerts are to be sent. Optionally, the user may provide additional information during the registration process, such as the user's name, address, etc.

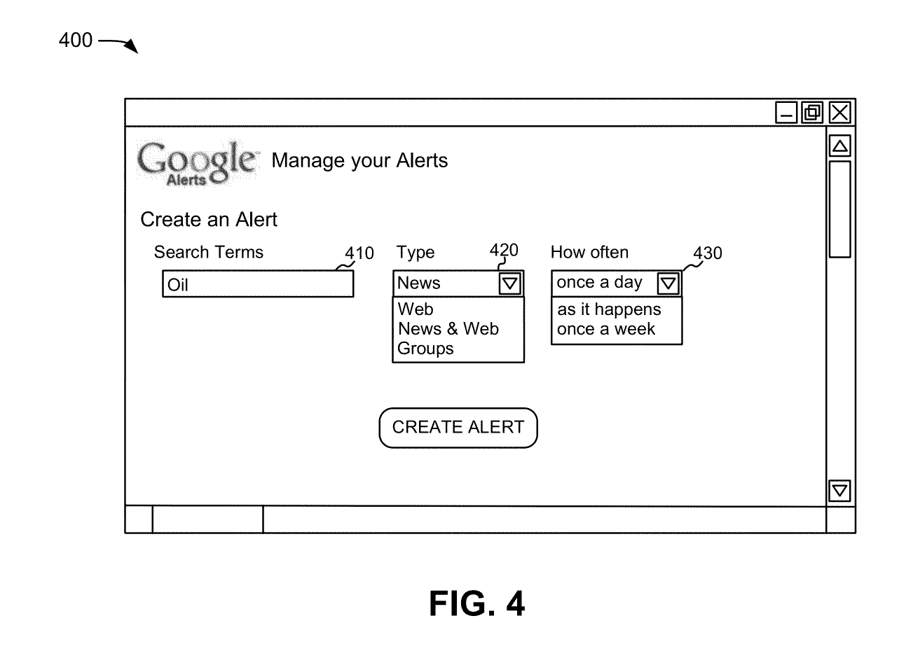

Once registered, the user may register new alerts as desired (act 304). Each alert may be registered by entering search terms that describe the subject for which the user would like to receive information. The registered alerts may be stored in database 131. FIG. 4 is a diagram illustrating an exemplary graphical interface 400 through which a user may register alerts. Interface 400 may include a field 410 through which the user may enter the search terms that correspond to the alert. In this example, the user has entered the search term “oil,” indicating that he would like to receive email alerts relating to oil.

In field 420, the user may select the type of documents to which the search terms are to be applied. In this example, the possible types of documents include “news,” “web,” “news and web,” and “groups.” The “news” type may indicate that the search terms of the alert are applied to newly received news documents, such as the documents indexed by a news search engine. The “web” type may indicate that the search terms of the alert are applied to newly indexed web documents, such as web pages indexed by a general web search engine. The “news and web” type may indicate that the search terms of the alert are applied to both news documents and web pages. The “groups” type may indicate that the search terms of the alert are applied to new documents that are indexed from Internet discussion groups. In this example, the user has chosen the “news” type, which means that the user is interested in news articles about oil.

In field 430, the user may select the frequency with which an alert email is sent to the user by alert engine 130. As shown in FIG. 4, example choices include “once a day,” “as it happens,” and “once a week.” Alert engine 130 may generate and transmit new email alerts to the user once every selected interval.

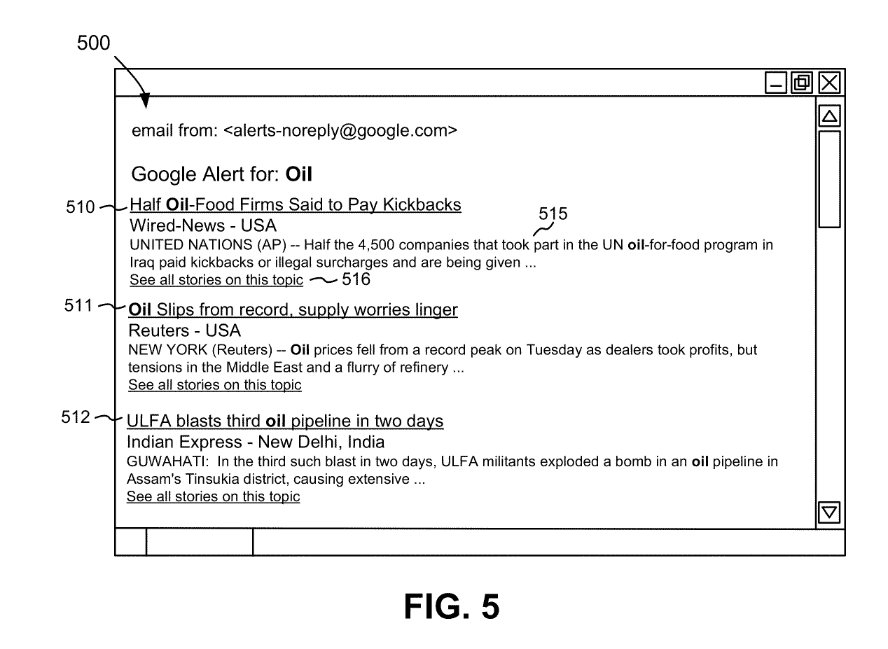

FIG. 5 is a diagram of an exemplary email alert displayed in a graphical interface. Email alert 500 may be an email alert from alert engine 130 that was generated based on the search term “oil.” Email alert 500 may include links 510-512 to documents (e.g., news stories) relevant to the alert. A link, such as link 510, may also be associated with a snippet 515 from the document and a second link 516 to additional documents similar to the main document. A user reading email alert 500 can quickly scan the email and select a document of interest for further viewing.

### Topical Subject Generator 135

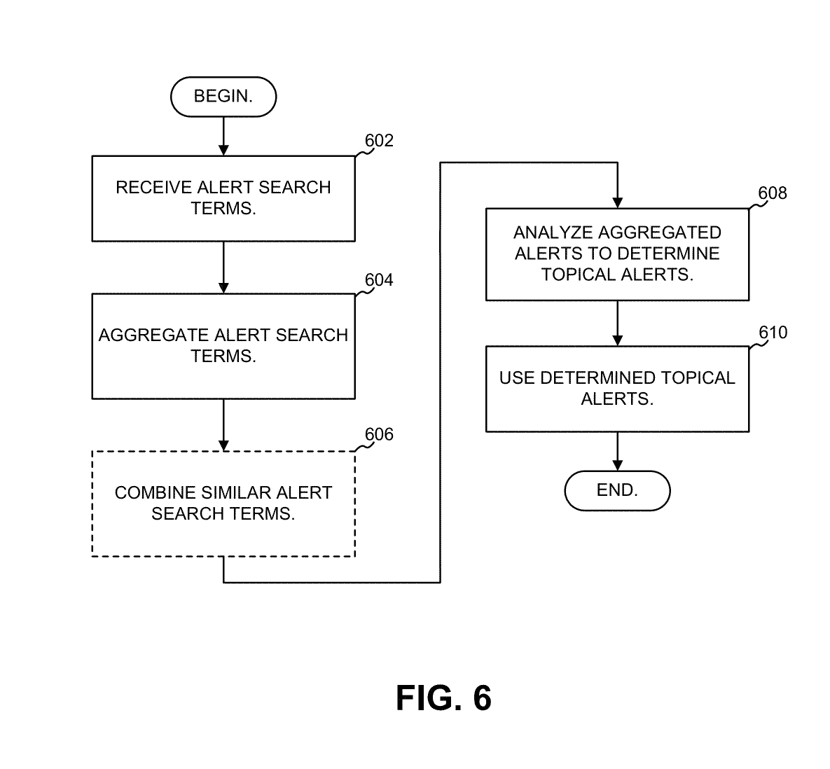

FIG. 6 is a flowchart illustrating exemplary operations performed by topical subject generator 135. As previously mentioned, topical subject generator 135 may analyze new alert search terms that users register with engine 130 to obtain alert search terms that are particularly popular. The analysis may be done over a certain period of time, such as the previous day, week, or month of new alert registrations, to obtain a list of alert search terms that the aggregate users of alert engine 130 consider to be topical.

The process shown in FIG. 6 may begin by topical subject generator 135 receiving alert search terms (act 602). The alert search terms may be received from alert engine 130 and may correspond to alerts registered over a predetermined time period. For example, the alerts may be newly registered alerts from the previous hour, day, week, or month. The length of the predetermined time period may be chosen by an operator of topical subject generator 135.

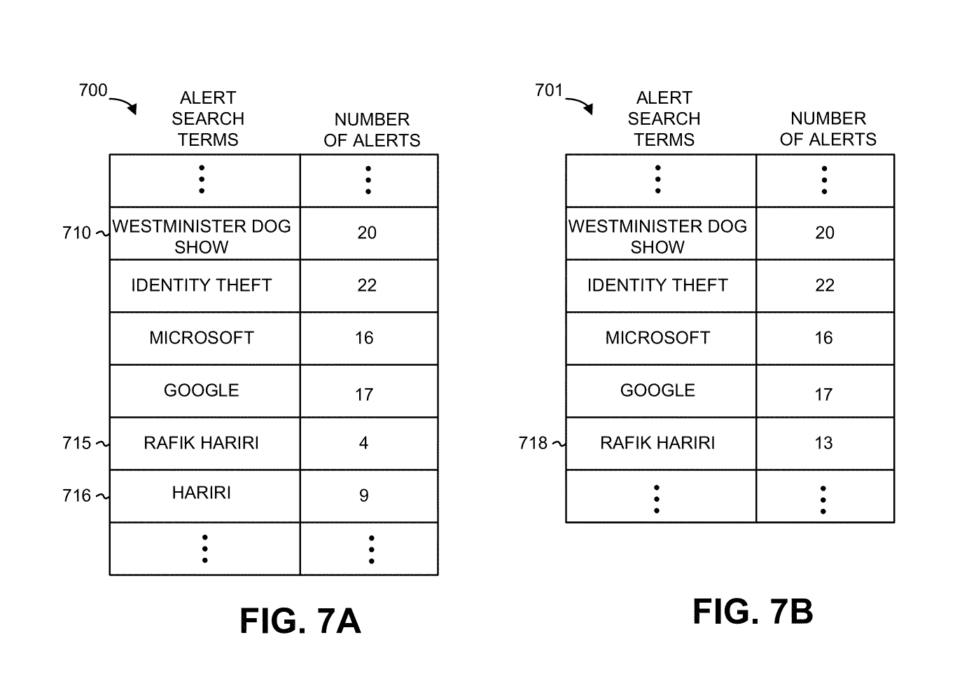

The alert search terms received in act 602 may be aggregated (act 604). FIG. 7A is a diagram illustrating an exemplary table 700 that illustrates aggregated alert search terms. Each row of table 700 may include a unique alert search term or phrase and the number of times that alert was registered. Row 710, for example, indicates that the search terms “Westminister Dog Show” were registered by 20 different users in the selected predetermined time period (e.g., one day).

Similar alert search terms in table 700 may optionally be combined (act 606). For example, row 715 in table 700 corresponds to alerts for “Rafik Hariri” and row 716 corresponds to alerts for “Hariri.” The users that created these alerts are probably all interested in the documents relating to the former prime minister of Lebanon, Rafik Bahaa Edine Hariri. Accordingly, rows 715 and 716 may be consolidated to create a single row with the alert search terms “Rafik Hariri,” which was requested 13 times. FIG. 7B is a diagram illustrating an exemplary table 701, which corresponds to table 700 after combining rows 715 and 716. As shown, row 718 in table 701 includes a single entry for “Rafik Hariri,” which was requested 13 times. The determination of whether two rows are similar or similar enough to combine may be based on a comparison of the alert search terms in the two rows using well known string comparison techniques.

The aggregated alerts, such as those shown in tables 700 or 701, may be used to determine alerts that are topical (act 608). A “topical” alert, as used herein, refers to one that has a predetermined level of popularity. Popularity can be measured by, for example, comparing the number of alert requests to a threshold value. For instance, in the example of table 701, topical subject generator 135 may be set to output any alert that was registered more than 18 times in the previous day as a topical alert. Accordingly, “Westminister Dog Show” and “Identity Theft” may be output as topical alerts.

In one implementation, instead of separately receiving alert search terms (act 602), aggregating the search terms (act 604), and analyzing the search terms (act 608), these acts can be performed in a single logical operation. For example, each registered alert may be stored in a database by alert engine 130. Topical subject generator 135 may directly search this database to perform acts 602, 604, and 608 using, for example, a single structured query language (SQL) query.

The alerts that are determined to be topical (act 608) by topical subject generator 135 may be used by alert engine 130, search engine 120, or by other processes, to enhance the user's online experience (act 610). For example, the topical alerts may be displayed to users on a web page as topics that are currently popular, presented to users as possible alerts that they may be interested in receiving, or used to assist in ranking search results of search engine 120.

### Exemplary Implementations using Topical Subject Generator 135

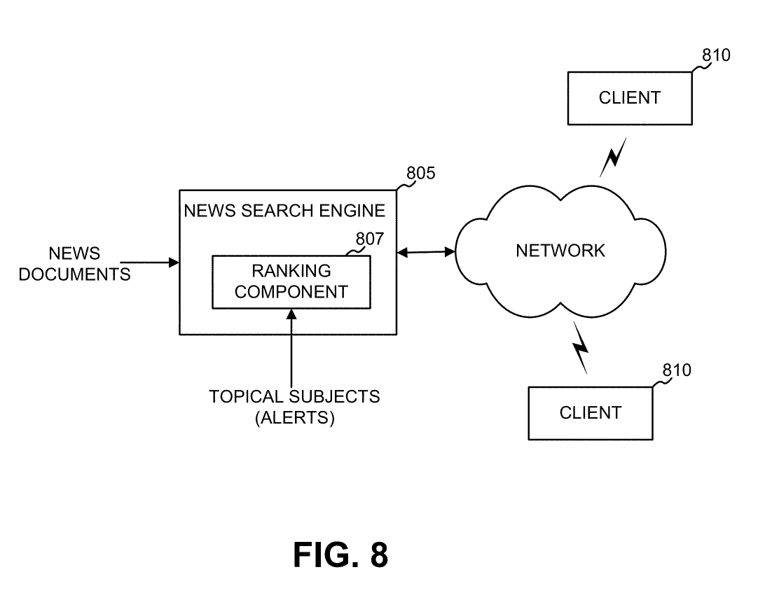

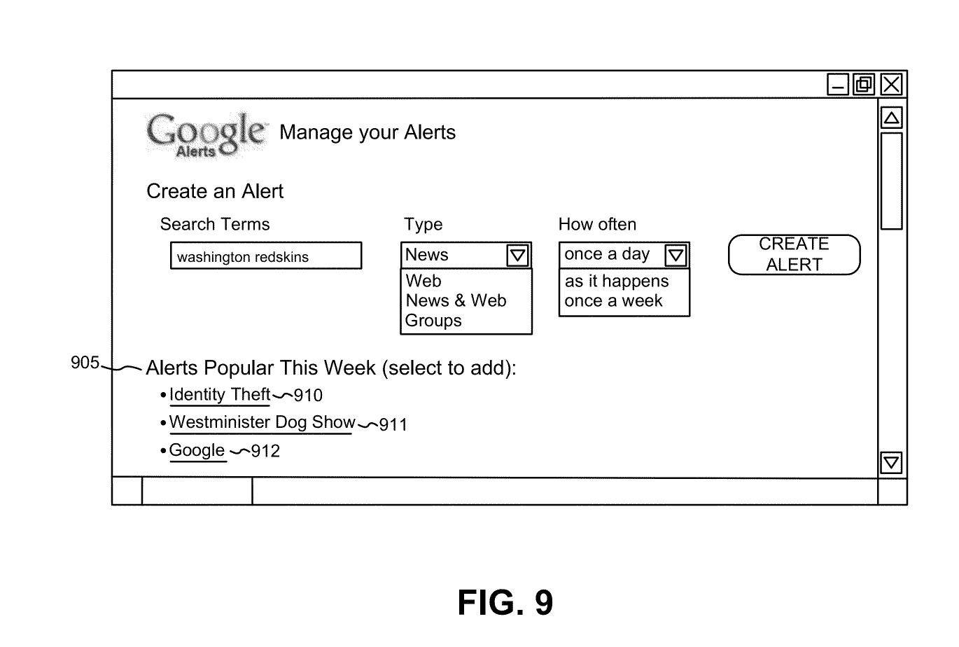

Specific examples of the use of the topical alerts generated by topical subject generator 135 will now be described with reference to FIGS. 8 and 9. As previously mentioned, the topical alerts generated by topical subject generator 135 are generally indicative of what users, as a whole, believe are currently interesting topics or subjects. As such, the topical alerts can be thought of as a signal of “what's interesting” and can be used to enhance the user experience in a number of ways.

One exemplary way that the topical alerts can be used to enhance the online experience for users is by using the topical alerts as signals that influence the rankings of search results returned by a search engine. In other words, the topical alerts generated by topical subject generator 135 can be used to improve results from search engine 120.

FIG. 8 is a diagram illustrating an exemplary implementation of a search engine that uses the topical alerts generated by topical subject generator 135. Search engine 805 may be a news search engine that is designed to return documents generated by online news sources that are relevant to search queries submitted by clients 810. In response to the client search queries, news search engine 805 may search a pre-indexed database (not shown) of news documents to generate a list of news stories that match the search query. This list of news stories may be ranked by a ranking component 807 designed to rank the documents according to relevance and/or importance.

Ideally, ranking component 807 should rank the list of news stories such that the news stories that most closely correspond to the information in which the client is interested are returned first. Ranking component 807 may use a number of known techniques to rank the initial list of news stories, such as techniques based on the degree to which the search query matches a news story and techniques based on an objective measure of quality, such as the source of the news story. Additionally, consistent with an aspect of the invention, ranking component 807 may additionally take into account a list of topical subjects, as generated by topical subject generator 135, when ranking the initial list of news stories. News stories that relate to subjects that are determined to be topical may receive a boost in their ranking values by ranking component 807.

Another possible way in which the topical alerts can be used to enhance the online experience of users is by presenting the topical subjects to the users as suggested alert search terms.

FIG. 9 is a diagram illustrating an exemplary implementation of an interface for creating new alerts, including alerts suggested by alert engine 130. The user interface shown in FIG. 9 is similar to the user interface shown in FIG. 4, except that an additional field 905 (“alerts popular this week”) is shown in FIG. 9. Field 905 may include a number of exemplary links 910-912, which allow the user to add a new alert by simply selecting one of links 910-912. Consistent with an aspect of the invention, links 910-912 may each correspond to a topical subject generated by topical subject generator 135. Pre-identifying possible alerts that a user may be interested makes it easier for users to sign up for new alerts. Additionally, the list of popular alerts may itself be of interest. In some implementations, alerts that are identified as alerts in which a user may be interested may be presented to users in other ways, such as by including them in other email alerts for which the user has already registered.

### CONCLUSION

Topical subject generator 135, as described above, identifies topical alerts by aggregating news alert search terms over a specified period of time. The topical alerts generally indicate what the user community as a whole considers to be interesting during the specified period of time.

The foregoing description of exemplary embodiments of the invention provides illustration and description, but is not intended to be exhaustive or to limit the invention to the precise form disclosed. Modifications and variations are possible in light of the above teachings or may be acquired from practice of the invention.

Moreover, while a series of acts have been described with regard to FIGS. 3 and 6, the order of the acts may be varied in other implementations consistent with the invention. Moreover, non-dependent acts may be implemented in parallel.

It will also be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” or as a “component” that performs one or more functions. This logic or component may include hardware, such as an application specific integrated circuit or a field programmable gate array, software, or a combination of hardware and software.

No element, act, or instruction used in the description of the invention should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1-29. (canceled)

30. A method performed by one or more server devices, the method comprising:
receiving, by one or more processors of the one or more server devices and from a plurality of user devices, a plurality of search terms when the plurality of user devices register for alerts relating to the plurality of search terms,
the plurality of search terms being received, over a particular period of time, from the plurality of user devices;
identifying, by the one or more processors of the one or more server devices, one or more search terms, of the plurality of search terms, that were received more than a threshold number of times over the particular period of time;
identifying, by the one or more processors of the one or more server devices, one or more topics relating to the one or more search terms based on identifying that the one or more search terms were received more than the threshold number of times over the particular period of time;
identifying, by the one or more processors of the one or more server devices, a plurality of documents relating to a search query, p2 a ranking, of each document of the plurality of documents, being based on the search query; and
modifying, by the one or more processors of the one or more server devices, the ranking of at least one document of the plurality of documents based on the one or more topics,
the at least one document relating to the one or more topics.

31. The method of claim 30, where modifying the ranking of the at least one document includes:
boosting the ranking of the at least one document based on the at least one document relating to the one or more topics.

32. The method of claim 30, where the one or more servers include a news search engine, and
where the plurality of documents includes news documents.

33. The method of claim 30, further comprising:
including information regarding the one or more topics in a web page; and
providing the web page to a user device,
the information indicating, to a user of the user device, that the one or more topics are popular.

34. The method of claim 30, further comprising:
including information regarding the one or more topics in a web page;
providing the web page to a user device;
receiving, from the user device, a request to transmit alerts to a user of the user device when one or more documents, relating to the one or more topics, are first identified by the one or more server devices,
receiving the request including detecting selection, by the user device, of the information regarding the one or more topics.

35. The method of claim 34, further comprising:
generating particular information when the one or more documents are first identified by the one or more server devices,
the particular information including:
a link to each document of the one or more documents, and
a portion of text from each document of the one or more documents; and
providing the particular information to the user device.

36. The method of claim 35, where providing the particular information includes:
providing the particular information, to the user device, via email.

37. The method of claim 30, where receiving the plurality of search terms includes:
receiving, from the plurality of user devices, requests to transmit alerts to users of the plurality of user devices when one or more documents, relating to one or more of a plurality of search terms, are first identified by the one or more server devices,
each request, of the requests, including at least one of the plurality of search terms.

38. A system comprising:
one or more server devices to:
receive, from a plurality of user devices, a plurality of search terms when the plurality of user devices register for alerts relating to the plurality of search terms,
the plurality of search terms being received, over a particular period of time, from the plurality of user devices;
analyze the plurality of search terms to identify one or more search terms, of the plurality of search terms, that were received more than a threshold number of times over the particular period of time;
identify one or more topics relating to the one or more search terms based on identifying that the one or more search terms were received more than the threshold number of times over the particular period of time;
identify a plurality of documents relating to a search query; and
rank the plurality of documents based on:
the search query, and
the one or more topics.

39. The system of claim 38, where the particular period of time includes an hour, a day, a week, or a month.

40. The system of claim 38, where, when analyzing the plurality of search terms, the one or more server devices are to:
combine one or more first search terms, of the plurality of search terms, and one or more second search terms of the plurality of search terms to obtain combined one or more search terms, and
analyze the combined one or more search terms to identify the one or more search terms.

41. The system of claim 38, where, when ranking the plurality of documents, the one or more server devices are to:
rank a first document, of the plurality of documents, higher than a second document of the plurality of documents based on:
the first document relating to the one or more topics, and
the second document not relating to the one or more topics.

42. The system of claim 38, where the one or more server devices are further to:
include information regarding the one or more topics in a web page; and
provide the web page to a user device,
the information indicating, to a user of the user device, that the one or more topics are popular.

43. The system of claim 38, where, when receiving the plurality of search terms, the one or more server devices are to:
receive, from the plurality of user devices, requests to transmit alerts to users of the plurality of user devices when one or more documents, relating to one or more of the plurality of search terms, are first identified by the one or more server devices,
each request, of the requests, including at least one of the plurality of search terms.

44. The system of claim 38, where the one or more server devices are further to:
include information regarding the one or more topics in a web page;
provide the web page to a user device;
receive, from the user device, a request to transmit alerts to a user of the user device when one or more documents, relating to the one or more topics, are first identified by the one or more server devices,
when receiving the request, the one or more server devices are to detect selection, by the user device, of the information regarding the one or more topics; and
provide, to the user device, particular information when the one or more documents are first identified by the one or more server devices,
the particular information including:
a link to each document of the one or more documents, and
a portion of text from each document of the one or more documents.

45. The system of claim 44, where, when providing the particular information to the user device, the one or more server devices are to:
provide the particular information, to the user device, via email.

46. A non-transitory computer-readable medium storing instructions, the instructions comprising:
a plurality of instructions which, when executed by one or more devices, cause the one or more devices to:
receive, from a plurality of user devices, a plurality of search terms,
the plurality of search terms being received, over a particular period of time, from the plurality of user devices;
identify one or more search terms, of the plurality of search terms, that were received more than a threshold number of times over the particular period of time;
identify one or more topics relating to the one or more search terms based on the one or more search terms being received more than the threshold number of times over the particular period of time;
identify a plurality of documents relating to a search query; and
rank the plurality of documents based on:
the search query, and
the one or more topics.

47. The non-transitory computer-readable medium of claim 46, where one or more instructions, of the plurality of instructions, to rank the plurality of documents include:
one or more instructions to rank a first document, of the plurality of documents, higher than a second document of the plurality of documents based on the first document relating to the one or more topics and the second document not relating to the one or more topics.

48. The non-transitory computer-readable medium of claim 46, where the instructions further include:
one or more instructions to include information regarding the one or more topics in a web page; and
one or more instructions to provide the web page to a user device,
the information indicating, to a user of the user device, that the one or more topics are popular.

49. The non-transitory computer-readable medium of claim 46, where the instructions further include:
one or more instructions to include information regarding the one or more topics in a web page;
one or more instructions to provide the web page to a user device;
one or more instructions to detect selection, by the user device, of the information regarding the one or more topics; and
one or more instructions to provide, to the user device, information regarding a document, relating to the one or more topics, when the document is first identified by the one or more devices,
the information regarding the document being provided to the user device based on detecting the selection of the information regarding the one or more topics.
